(19) United States
(12) Patent Application Publication
(10) Pub. No.: US 2015/0188625 A1
(43) Pub. Date: Jul. 2, 2015

(54) METHOD FOR REALIZING TIME REDUCTION IN SHARED MESH NETWORK

(71) Applicant: ELECTRONICS AND TELECOMMUNICATIONS RESEARCH INSTITUTE, Daejeon (KR)

(72) Inventors: Chan Sung PARK, Changwon-si (KR); Dae Ub KIM, Daejeon (KR); Sun Me KIM, Daejeon (KR); Tae IL KIM, Daejeon (KR); Jong Seok LEE, Daejeon (KR); Jong Hyun LEE, Daejeon (KR)

(21) Appl. No.: 14/583,273

(22) Filed: Dec. 26, 2014

(30) Foreign Application Priority Data
Dec. 27, 2013 (KR) 10-2013-0165321
Aug. 22, 2014 (KR) 10-2014-0109606

(51) Int. Cl. H04B 10/032; H04Q 11/00; H04B 10/27

(52) U.S. Cl. CPC H04B 10/032; H04B 10/27; H04Q 11/0062; H04Q 2011/0081

(57) ABSTRACT

Provided herein is a method for realizing time reduction in shared mesh protection, the method including, in a protection path node, in response to a resource being used for a first protection path by a node, receiving a resource use request for setting a second protection path from another node; activating a protection switch through comparison of priorities of protection paths at the resource use request received; and transmitting, by the activation of a protection switch, to a next protection path node a first shared mesh protection message where a revert (RT) message for the first protection path and a protection switch (SF) message for setting a second protection path are multiplexed.

### CROSS-REFERENCE TO RELATED APPLICATION

The present application claims priority to Korean patent application numbers 10-2013-0165321, filed on Dec. 27, 2013 and 10-2014-0109606, filed on Aug. 22, 2014, the entire disclosure of which is incorporated herein in its entirety by reference.

### BACKGROUND

1. Field of Invention

Various embodiments of the present invention relate to an optical communication network system, and more particularly to a method for realizing time reduction in shared mesh protection where a time delay for setting a protection path in an ODU (Optical Data Unit) layer of an OTN (Optical Transport Network) is reduced.

2. Description of Related Art

In order to realize a protection switch using a shared resource in an optical communication network between a starting point and an end point, information for preoccupying a resource distributed in a protection path must be transceived and synchronized. For this purpose, one protection path may be shared by multiple normal signals through SMP (Shared Mesh Protection). Instead of having an exclusive protection path, a normal signal may preoccupy the protection path according to an order of priority. There may be more than one protection path for each normal signal, and if a normal signal fails an attempt to preoccupy the protection path, it may preoccupy an alternative protection path so as to realize a protection switch.

Herein, an operation of preoccupying a protection path may have to be made by another normal signal having a high order of priority. After a previous protection path is released, an operation has to be performed to allocate a resource to an activated protection path, thereby causing a problem of time delay for setting a protection path.

### SUMMARY

A first purpose of various embodiments of the present invention is to provide a method for realizing time reduction in shared mesh protection where a time delay for preoccupying a protection path is reduced.

According to an embodiment of the present invention, there is provided a method for realizing time reduction in shared mesh protection, the method including, in a protection path node, when a resource is used for a first protection path by a node, receiving a resource use request for setting a second protection path from another node; activating a protection switch through comparison of priorities of protection paths at the resource use request received; and transmitting, by the activation of a protection switch, to a next protection path node a first shared mesh protection message where a revert (RT) message for the first protection path and a protection switch (SF) message for setting a second protection path are multiplexed.

According to the embodiment of the present invention, the method may further include, in response to receiving the resource use request for setting a second protection path, transmitting a shared resource release (REL) message to a starting node that is using the first protection path; and receiving the revert message from the starting node.

According to the embodiment of the present invention, the method may include, in response to the transmission of the first shared mesh protection message, receiving from the next protection path node a second shared mesh protection message where a shared resource release (RR) message and an availability (AV) message are multiplexed; and demultiplexing the second shared mesh protection message, and transmitting the shared resource release (RR) message to a starting node of the first protection path and transmitting the availability (AV) message to a starting node of the second protection path.

According to the embodiment of the present invention, the first shared mesh protection message may incorporate the revert (RT) message and protection switch (SF) message in each of a plurality of shared protection mesh overhead areas.

According to the embodiment of the present invention, the second shared mesh protection message may incorporate the shared resource release (RR) message and availability (AV) message in each of a plurality of shared protection mesh overhead areas.

According to the embodiment of the present invention, the method may further include transmitting to the next protection path node the shared resource release (RR) message corresponding to the receiving of the second shared mesh protection message.

According to an embodiment of the present invention, there is provided a method for realizing time reduction of shared mesh protection, the method including in a protection path node, receiving a first shared mesh protection message where a revert (RT) message for a first protection path and a protection switch (SF) message for setting a second protection path are multiplexed; demultiplexing the first shared mesh protection message, and transmitting the revert (RT) message to an end node of the first protection path and transmitting the protection switch (SF) message to an end node of the second protection path; receiving a shared resource release (RR) message corresponding to the revert (RT) message from the end node of the first protection path; transmitting an availability (AV) message to an end node of the second protection path, and receiving a shared resource release (RR) message corresponding to the availability message; and transmitting to a previous protection path node that transmitted the first shared mesh protection message a second shared mesh protection message where the shared resource release (RR) message and availability message are multiplexed.

According to the embodiment of the present invention, the first shared mesh protection message may incorporate the revert (RT) message and protection switch (SF) message in each of a plurality of shared protection mesh overhead areas.

According to the embodiment of the present invention, the second shared mesh protection message may incorporate the shared resource release (RR) message and availability (AV) message in each of a plurality of shared protection mesh overhead areas.

According to the embodiment of the present invention, the method may further include receiving a shared resource release (RR) message corresponding to the transmitting of the second shared mesh protection message from the previous protection path node.

A method for realizing shared mesh according to various embodiments of the present invention transmits a shared protection mesh message to more than one subordinate signals with one signal, thereby reducing the time delay caused by a temporary pending that occurs during preoccupying a protection path.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is an exemplary view of a layer multiplex configuration of an optical transmission network;

FIG. 2 is an exemplary view of an overhead automatic protection switch channel of an optical data unit layer;

FIG. 3 is an exemplary view of a network for shared mesh protection;

FIG. 4 is an exemplary view of an information table used in a shared node;

FIG. 5 is an exemplary view of an operation of preoccupying a protection path in nodes having the structure of FIG. 3; and

FIG. 6 is an exemplary view of an operation of preoccupying a protection path according to an embodiment of the present invention.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

Various embodiments of the present invention may provide a technology of realizing shared mesh protection (hereinafter referred to as ‘SMP’) in an optical data unit (hereinafter referred to as ‘ODU’) layer of an optical transport network (hereinafter referred to as ‘OTN’).

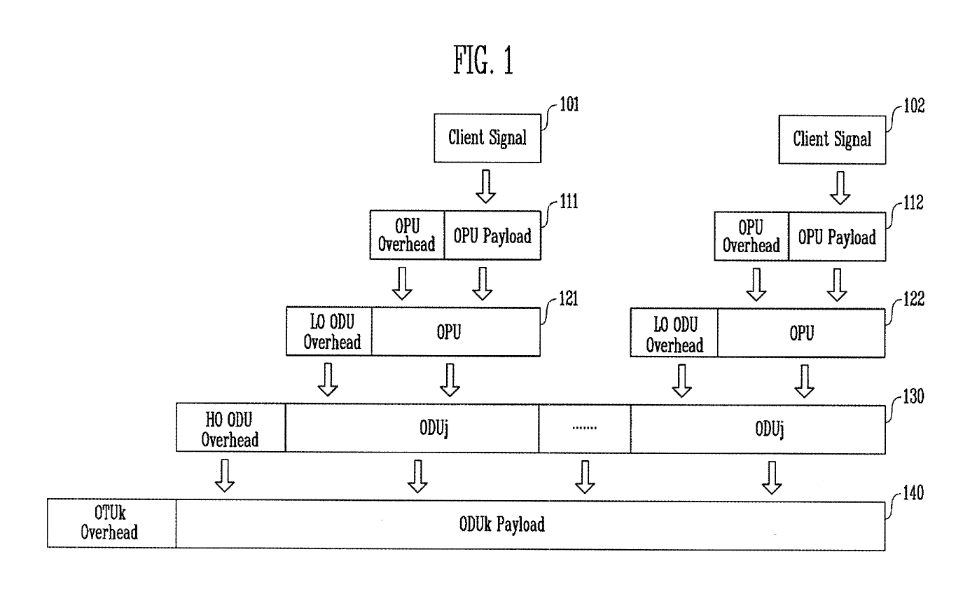

FIG. 1 is an exemplary view of a layer multiplex configuration of an optical transmission network.

Referring to FIG. 1, OTN is an optical layer transmission method standardized by the International Telecommunications Union-Telecommunication (ITU-T), and includes four digital layers. Herein, a digital layer includes an optical payload unit (hereinafter referred to as ‘OPU’), ODU, optical transfer unit (hereinafter referred to as ‘OTU’), and optical channel (hereinafter referred to as ‘Och’).

Each of OPU frames 111, 112 includes an OPU overhead and OPU payload. Therefore, each of user signals 101, 102 may be included in the OPU payloads.

An ODU layer may be divided into a HO (High Order)/ODUk and a LO (Low Order)/ODUj, the HO (High Order)/ODU being a layer that is directly coupled to the OTU, and the LO/ODU being a layer multiplexed into an HO/ODU. The hierarchy of ODU may be classified into ODUk (k=1, 2, 3, 4, flex).

Herein, an LO ODU frame 121 includes an LO ODU overhead and an OPU frame 111, and an LO ODU frame 122 includes an LO ODU overhead and an OPU frame 112. Numerous LO ODU frames 121, 122 may be multiplexed into one HO ODU frame 130.

An HO ODU frame 130 includes an HO ODU overhead and the LO ODU frames 121, 122.

An OTU frame 140 includes an OTUk overhead and an HO ODU frame 130.

Herein, the signal transmission unit is a tributary slot (hereinafter referred to as ‘TS’), and the size of a TS may be 1.25G or 2.5G, and each TS is given an ID number. An ODU signal has a structure such that it may be divided into numerous TS and transmitted according to hierarchy. When transmitting an ODU2 (about 10G) signal and using a TS of 1.25G, eight TS are required. Herein, the ID number of each TS may be configured differently according to the system.

Before development of the SMP, the OTN protection switch method standardized by ITU-T had two types: linear protection switch and ring protection switch. Each protection switch is performed by inserting an operation method according to the protection switch rules of the automatic protection switch (hereinafter referred to as ‘APS’) of the overhead of the ODU layer. One normal signal has a protection path allocated exclusively.

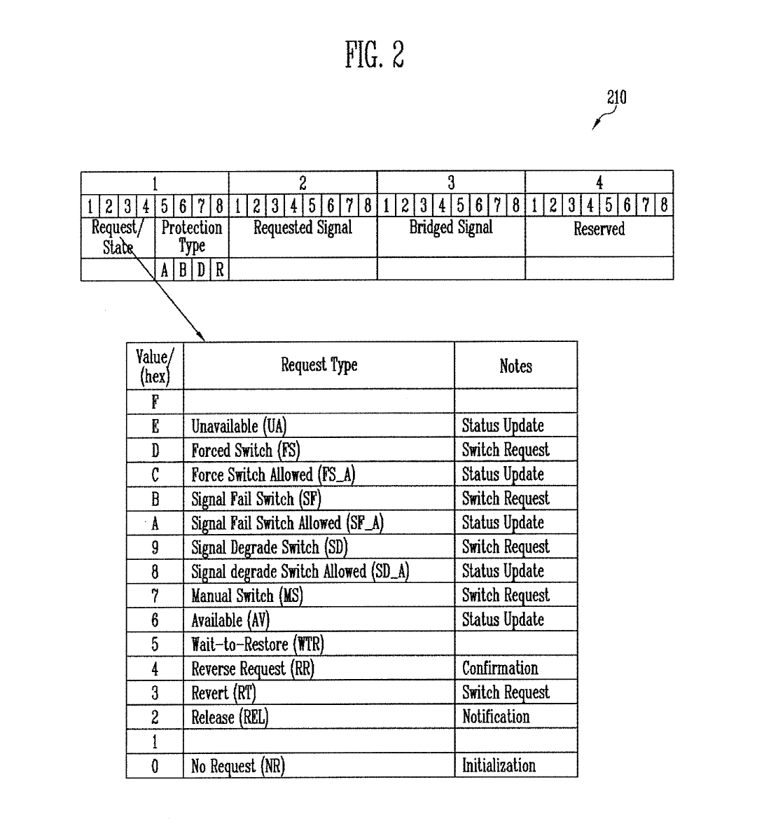

FIG. 2 is an exemplary view of an overhead automatic protection switch channel of an optical data unit layer.

Referring to FIG. 2, an APS channel 210 may consist of 4 bytes. The first byte includes information on a Request/State (that is, request for a protection switch) and protection type (that is, information on setting a protection switch), and the second byte includes information on a request signal, that is information on the signal that needs a protection switch. Furthermore, the third byte includes information on a bridged signal, that is a signal that is currently being transmitted along the protection path, and the fourth byte includes reserved bits.

Furthermore, values of Request/State fields of the APS channel 210 are shown. For example, values on Request/State fields may be expressed in hexadecimals, and values from 0 to 9 and A to F expressed in hexadecimals may be defined as below.

For example, ‘0’ represents NR (No Request), and is used in initialization. ‘2’ represents REL (Release), and is used in notification. ‘3’ represents RT (Revert), and is used in switch request. ‘4’ represents RR (Reverse Request), and is used in confirmation. ‘5’ represents WTR (Wait-to-Restore) for storing. ‘6’ represents AV (Available), and is used in status update. ‘7’ represents MS (Manual Switch), and is used in switch request. ‘8’ represents SD A (Signal Degrade Switch Allowed), and is used in status update. ‘9’ represents SD (Signal Degrade Switch) and is used in switch request. ‘A’ represents SF_A (Signal Fail Switch Allowed) and is used in status update. ‘B’ represents SF (Signal Fail Switch) and is used in switch request. ‘C’ represents FS_A (Force Switch Allowed), and is used in status update. ‘D’ represents FS (Forced Switch), and is used in switch request. ‘D’ represents FS (Forced Switch) and is used in switch request. ‘E’ represents UA (Unavailable) and is used in status update. Meanwhile, ‘1’ and ‘F’ are not defined.

Information must be transceived and synchronized between a starting point and end point, for example, between a starting node and end node. For this purpose, the information being transceived includes identification information on a signal intending to use a protection path, identification information on a signal using the protection path, protection path regulation information for designing a network, and required operation information etc.

SMP is a concept of one protection path being shared by a plurality of normal signals. Instead of using an exclusive protection path, a normal signal may preoccupy a protection path according to a priority. There may be numerous protection paths for one normal signal, and when a preoccupation attempt fails, a normal signal may preoccupy an alternative protection path and perform a protection switch.

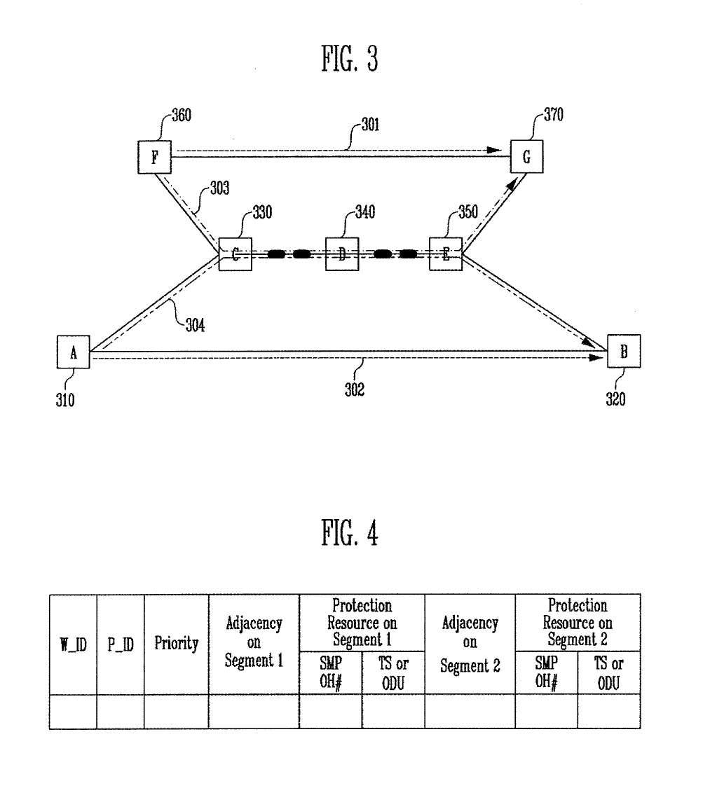

FIG. 3 is an exemplary view of a network for shared mesh protection.

Referring to FIG. 3, the network includes 310, 320, 330, 340, 350, 360, and 370.

In node F 360, a first normal path 301 to node G 370 is set, and in node A 310, a second normal path 302 to node B 320 is set.

Herein, a first protection path 303 for a first normal path 301 may consist of node F 360, node C 330, node D 340, node E 350, and node G 370, sequentially.

Furthermore, a second protection path 304 for a second normal path 302 may consist of node A 310, node C 330, node D 340, node E 350, and node B 320, sequentially.

Furthermore, of the two protection paths 303, 304, node C 330, node D 340, and node E 350 that are repeated each consists of an HO ODU path fragmented in C-D, D-E, and two protection paths 303, 304 multiplexed into these HO ODU paths 303, 304 enable setting a protection path using a resource shared in units of TS.

For example, looking from the first protection path 303, a path from node F 360 to node C 330 (F->C) and a path from node E 350 to node G 370 (E->G) transmit an ODUj hierarchy signal. Furthermore, a path from node C 330 to node D 340 (C->D), and a path from node D 340 to node E 350 (D->E) each transmits an ODUk hierarchy signal. Transmitting an independent ODUk hierarchy signal makes demultiplexing and multiplexing to reoccur in each node C 330, node D 340, and node E 350, and this is a procedure necessary when another protection path configuration is possible in node D through a node besides the three aforementioned nodes.

In order to realize SMP, identification information such as identification of a signal to be transmitted to a protection path and identification of a signal currently being used in the protection path must be transmitted and synchronized. In a linear protection switch or ring protection switch method, such information is inserted into an APS channel included in an overhead of an ODU frame and then transmitted. On the other hand, in SMP, due to increased complexity of realization caused by consideration of the priorities of paths sharing a resource, setting a next adjacent node when configuring a shared path, TS information to be used of the shared resource, and location of the overhead to which a switch request is to be inserted, and numerous types of information required, the necessary contents are divided and stored and transmitted through an APS channel and an information table. Herein, the information table is used in a shared node (for example, node C 330, node D 340, and node E 350), and includes information to be set when designing the network.

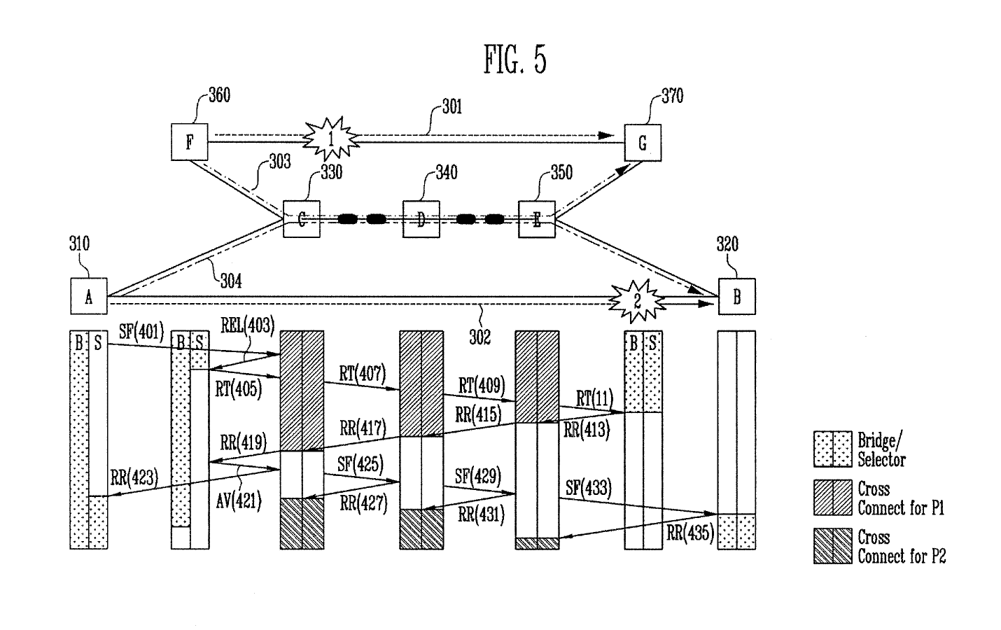

FIG. 4 is an exemplary view of an information table used in a shared node.

Referring to FIG. 4, the information table includes a normal signal identifier (W_ID), protection signal identifier (P_ID), priority, adjacency on segment, and protection resource.

Herein, the normal signal identifier (W_ID) is identifier information for identifying a normal signal that signals a switch. The protection signal identifier (P_ID) is an identifier for identifying a signal corresponding to a normal signal that must be protected. The priority is information on a priority of a signal for supporting a preoccupation mechanism. The adjacency on segment is information on inputs and outputs used in a signal, each indicating a node from which a received node is transmitted and a destination node where a signal to be transmitted will arrive. The protection resource is resource information that a signal uses. It represents information on a location where a switch request regarding a signal currently configuring a protection path is stored in an HO ODU APS channel overhead, and information on TS that a current node intends to use as a protection resource.

When a particular signal attempts a switch using the information table, a collision with a signal currently using the protection path must be resolved through comparison of priorities. Furthermore, when a switch is allowed, the information table enables a cross-connect through resource information that must be allocated in a node.

When an error occurs in a shared node and resource, status information must be disseminable end to end regarding all ODUj signals utilizing a shared resource. However, when two different signals compete to use a same shared resource, only one signal may use the shared resource at one time. Therefore, information on all ODUj (for example, up to 80) must be multiplexed into an ODUk signal and be transmitted. In order to realize such a method, a frame overhead APS channel format of the ODUk signal needs to be changed. An APS channel consists of 4 bytes, Request/State information on one ODUj signal being included in every 4 bits. Furthermore, 8 ODUj signal information may be included in every ODUk frame. Each 4 bit overhead (SMP OH) may be used exclusively for information on a certain signal, and it is possible to identify a signal sequentially and compare with the information table managed in each shared node.

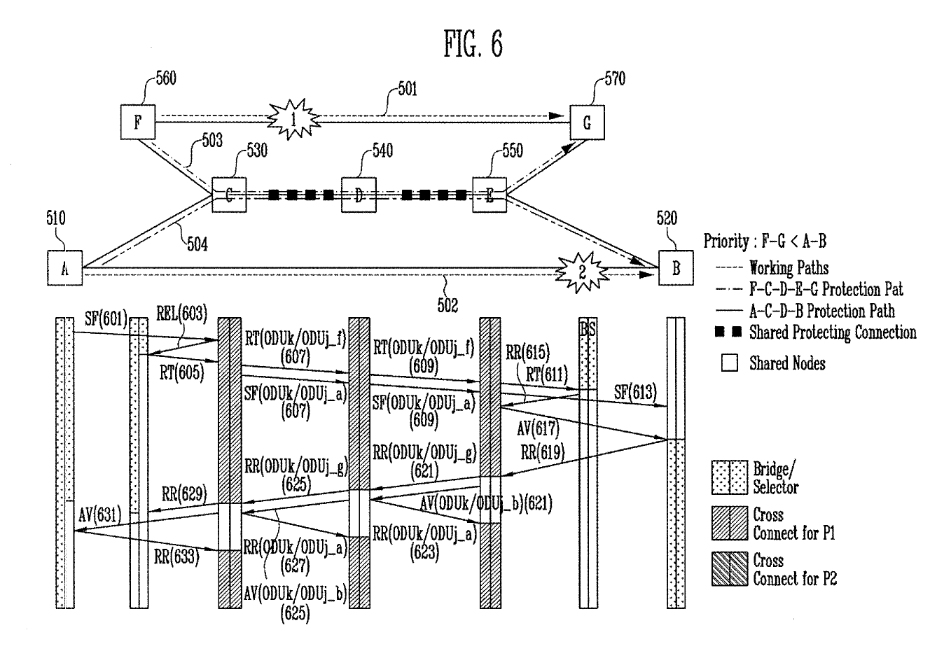

FIG. 5 is an exemplary view of an operation of preoccupying a protection path in nodes having a structure of FIG. 3.

Referring to FIG. 5, for detailed description on structures of nodes 310, 320, 330, 340, 350, 360, and 370, normal paths 301, 302, and protection paths 303, 304, see FIG. 3.

First of all, a signal error 1 occurs between node F 360 and node G 370. Herein, node C 330, node D 340, and node E 350 configure a first protection path 303 for protecting a signal being transceived along a first normal path 301. Herein, an error 2 may occur in a second normal path 302 (node A 301-node B 320) having a higher priority than the first normal path 301 (node F 360-node G 370). Herein, node A 310 attempts to preoccupy a shared resource of node C 330, node D 340, and node E 350.

Node A 310 transmits a request for protection switch (hereinafter referred to as ‘SF’) to a node on the protection path that has been preset according to occurrence of error 2 (step 401).

Node C 330 receives an SF message from node A 310, and compares the priorities of the signal from node A 310 and of a signal of the first protection path 303 currently using the resource.

By comparing the priorities, node C 330 may confirm that the SF message of node A 310 has a higher priority. Then, node C 330 transmits a release message for the currently using shared resource (hereinafter referred to as ‘REL’) to node F 360 (step 403). Herein, the SF message of node A 310 is temporarily pended until all shared resources preoccupied by node F 360-node G 370 are released (step 405).

Node F 360 transmits a revert (hereinafter referred to as ‘RT’) message to Node C 330

Node C 330 transmits an RT message to node D 340 (step 407).

Node D 340 that received the RT message transmits the RT message to node E 350 (step 409).

Node E 350 that received the RT message transmits the RT message to node G 370 (step 411).

Upon receiving the RT message, node G 370 transmits a shared resource release message (hereinafter referred to as ‘RR’) to node E 350 in response to the RT message (step 413). The node that received the RR message releases the path that was set (for example, cross-connect).

Node E 350 that received the RR message transmits the RR message to node D 340 (step 415).

Node E 340 that received the RR message transmits the RR message to node C 330 (step 417).

Node C 330 that received the RR message completes a cross connect release of the shared resource in previous nodes through the RR message. Herein, since the shared resource is not preoccupied, node C 330 transmits the RR message representing completion of a cross-connect release to node F 360 (step 419).

Node F 360 transmits an availability (hereinafter referred to as ‘AV’) message that represents that a shared resource is available to node C 330 (step 421).

Through receiving the AV message, node C 330 transmits the RR message representing that a protection path may be set to node A 310 (step 423). Furthermore, node C 330 transmits the temporarily pended SF message to node D 340 (step 425).

Upon receiving the SF message, node D 340 transmits the RR message to node C 330 (step 427). Furthermore, node D 340 transmits the SF message to node E 350 (step 429).

Upon receiving the SF message, node E 350 transmits the RR message to node D 340 (step 431). Furthermore, node E 350 transmits the SF message to node B 320 (step 433).

Upon receiving the SF message, node B 320 transmits the RR message to node E 350 (step 435).

As such, upon normally receiving the SF message, node D 340, node E 350, and node B 320 transmit a response to the RR message to the node that transmitted the SF message to itself. By the aforementioned, in the node that received the RR message, setting a cross-connect for setting a second protection path 304 between node A 310 and node B 320 is completed.

When all steps to step 435 are completed, the preoccupying operation of setting the second protection path 304 is completed.

Hereinafter are proposals for operations for reducing time for allocating resources to a protection path to be activated after an existing protection path (for cross-connect) for activating a protection path having a higher priority is released in the process of preoccupying a shared resource.

FIG. 6 is an exemplary view of operations for preoccupying a protection path according to an embodiment of the present invention.

Referring to FIG. 6, a network includes nodes 510, 520, 530, 540, 550, 560, and 570. Herein, the network is similar to the network illustrated in FIG. 3, and thus refer to the explanation on the network of FIG. 3.

First of all, a signal error 1 occurs between node F 560 and node G 570. Herein, node C 530, node D 540, and node E 550 are used as a protection path 504 for protecting a signal being transceived along a second normal path 502. Herein, an error 2 may occur in a first normal path 501 (node A 510-node B 520) having a higher priority than the second normal path 502 (node F 560-node G 570). Herein, node A 510, node C 530, node D 540, and node E 550 attempt preoccupying a shared resource.

Meanwhile, node A 510 and node F 560 may be defined as starting nodes, and node B 520 and node G 570 may be defined as end nodes. Herein, node C 530, node D 540, and node E 550 may be defined as protection path nodes on a protection path.

Node A 510 is a node on a protection path preset according to occurrence of an error 2 (for example, node C 530), and transmits a request for protection switch (hereinafter referred to as ‘SF’) message (step 601).

Node C 530 receives an SF message from node A 510, and compares priorities of a signal from node A 510 and a signal transmitted through the first protection path 503 currently using a resource.

By comparing the priorities, node C 530 may confirm that the signal of node A 510 that transmitted the SF message has a higher priority. Then, when a protection switch is possible, node C 530 transmits a release message of a resource currently being used (hereinafter referred to as ‘REL’) to node F 560 (step 603). Herein, transmission of the SF message of node A 510 is temporarily pended.

Upon receiving the REL message, node F 560 transmits a revert (hereinafter referred to as ‘RT’) message to node C 530 (step 605).

Herein, node C 530 manages both the SF message received from node A 510 and the RT message received from node F 560. Upon receiving the RT message from node F 560, when multiplexing into an ODUk signal, node C 530 incorporates the RT message (ODUk/ODUj_f) into a first SMP overhead area (SMP OH#1) and incorporates the SF message (ODUk/ODUj_a) into a second SMP overhead area (SMP OH#2), and transmits the first SMP overhead area (SMP OH#1) and the second SMP overhead area (SMP OH#2) to next node D 540 (step 607).

Upon receiving an SMP message multiplexed into an ODuk, node D 540 copies the received SMP message and transmits the copied SMP message to next node E 550 (step 609). Herein, the SMP message includes the RT message (ODUk/ODUj_f) and SF message (ODUk/ODUj_a).

Node E 550 that received the SMP message demultiplexer the SMP message and obtains SMP OH#1 and SMP OH#. Then, node E 550 transmits the RT message included in SMP OH#1 to node G 570 (step 611), and transmits the SF message included in SMP OH#2 to node B 520 (step 613). Herein, node E 550 may transmit the RT message and SF message to node G 570 and node B 520 at the same time.

Upon receiving the RT message, node G 570 transmits the RR message corresponding to the RT message to node E 550 (step 615).

Upon receiving the RR message from node G 570 by transmission of the RI message, node E 550 transmits an AV message representing that its shared resource is available to node B 520 (step 617).

Node B 520 that received the AV message resumes the protection switch process that was temporarily pended. Herein, node B 520 changes the setting of a bridge and selector, and transmits the RR message representing completion of change (confirmation) to node E 550 (step 619).

Upon receiving the RR message for setting a new protection path (second protection path 504) from node B 520, node E 550, when multiplexing into an ODUk signal, incorporates the RR message (ODUk/ODUj_g) into SMP OH#1 area and incorporates the AV message (ODUk/ODUj_b) into SMP OH#2 area, and transmits the SMP OH#1 area and SMP OH#2 area to node D 540 (step 621).

Node D 540 that received the SMP message transmits the RR message (ODUk/ODUj_a) to node E 550 (step 623). Furthermore, node D 540 copies the SMP message received and transmits the copied SMP message to next node C 530 (step 625). Herein, the SMP message includes the RR message (ODUk/ODUj_g) and AV message (ODUk/ODUj_b).

Node C 530 that received the SMP message transmits the RR message (ODUk/ODUj_a) to node D 540 (step 627). Furthermore, node C 530 demultiplexes the SMP message and obtains SMP OH#1 and SMP OH#2. Then, node C 550 transmits the RR message included in SMP OH#1 to node F 560 (step 629), and transmits the AV message included in SMP OH# to node A 510 (step 631). Herein, node C 530 may transmit the RR message and AV message to node F 560 and node A 510 at the same time.

Furthermore, node F 560 that received the RR message may confirm that the release of the shared resource has been normally completed. Node A 510 that received the AV message may confirm that setting a protection path has been normally completed.

Node A 510 that received the AV message transmits the RR message to node C 530 (step 633).

In conventional methods, when two different signals have to share a same certain TS of a shared resource, only one signal can be transmitted through a protection path. Thus, the process is divided into two operations: releasing the shared resource, and then preoccupying the shared resource. Due to a time delay that occurs for releasing the shared resource the process of preoccupying the shared resource is temporarily pended, and thus the time delay increases according to the number of shared resources and distance between nodes. Consequently, the minimum switch time of 50 ms which is the most important factor in a protection switch cannot be guaranteed.

The aforementioned various embodiments of the present invention may integrate the two divided operations into one operation through a method for realizing a shared mesh, thereby reducing the time delay. For this purpose, in a shared resource path (that is, protection path), an SMP message for numerous subordinate signals are transmitted by one signal. This reduces the temporary pending operation time that occurs when preoccupying the resource, thereby reducing the time spent in activating a protection path.

In the drawings and specification, there have been disclosed typical embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method for realizing time reduction in shared mesh protection, the method comprising:
in a protection path node, when a resource is used for a first protection path by a node, receiving a resource use request for setting a second protection path from another node;
activating a protection switch through comparison of priorities of protection paths at the resource use request received; and
transmitting, by the activation of a protection switch, to a next protection path node a first shared mesh protection message where a revert (RT) message for the first protection path and a protection switch (SF) message for setting a second protection path are multiplexed.

2. The method according to claim 1,
further comprising, in response to receiving the resource use request for setting a second protection path, transmitting a shared resource release (REL) message to a starting node that is using the first protection path; and
receiving the revert message from the starting node.

3. The method according to claim 1, the method comprising:
in response to the transmission of the first shared mesh protection message, receiving from the next protection path node a second shared mesh protection message where a shared resource release (RR) message and an availability (AV) message are multiplexed; and
demultiplexing the second shared mesh protection message, and transmitting the shared resource release (RR) message to a starting node of the first protection path and transmitting the availability (AV) message to a starting node of the second protection path.

4. The method according to claim 3,
wherein the first shared mesh protection message incorporates the revert (RT) message and protection switch (SF) message in each of a plurality of shared protection mesh overhead areas.

5. The method according to claim 3,
wherein the second shared mesh protection message incorporates the shared resource release (RR) message and availability (AV) message in each of a plurality of shared protection mesh overhead areas.

6. The method according to claim 3,
further comprising transmitting to the next protection path node the shared resource release (RR) message corresponding to the receiving of the second shared mesh protection message.

7. A method for realizing time reduction of shared mesh protection, the method comprising:
in a protection path node, receiving a first shared mesh protection message where a revert (RT) message for a first protection path and a protection switch (SF) message for setting a second protection path are multiplexed;
demultiplexing the first shared mesh protection message, and transmitting the revert (RT) message to an end node of the first protection path and transmitting the protection switch (SF) message to an end node of the second protection path;
receiving a shared resource release (RR) message corresponding to the revert (RT) message from the end node of the first protection path;
transmitting an availability (AV) message to an end node of the second protection path, and receiving a shared resource release (RR) message corresponding to the availability message; and
transmitting to a previous protection path node that transmitted the first shared mesh protection message a second shared mesh protection message where the shared resource release (RR) message and availability message are multiplexed.

8. The method according to claim 7,
wherein the first shared mesh protection message incorporates the revert (RT) message and protection switch (SF) message in each of a plurality of shared protection mesh overhead areas.

9. The method according to claim 7,
wherein the second shared mesh protection message incorporates the shared resource release (RR) message and availability (AV) message in each of a plurality of shared protection mesh overhead areas.

10. The method according to claim 7,
further comprising receiving a shared resource release (RR) message corresponding to the transmitting of the second shared mesh protection message from the previous protection path node.
